(19) United States
(12) Patent Application Publication
(10) Pub. No.: US 2013/0033597 A1
(43) Pub. Date: Feb. 7, 2013

(54) CAMERA SYSTEM AND METHOD FOR RECOGNIZING DISTANCE USING THE SAME

(71) Applicants: Hae Jin Jeon, Gyunggi-do (KR); Joo Young Ha, Gyunggi-do (KR); In Taek Song, Gyunggi-do (KR)

(72) Inventors: Hae Jin Jeon, Gyunggi-do (KR); Joo Young Ha, Gyunggi-do (KR); In Taek Song, Gyunggi-do (KR)

(73) Assignee: SAMSUNG ELECTRO-MECHANICS CO., LTD., Gyunggi-do (KR)

(21) Appl. No.: 13/475,290

(22) Filed: May 18, 2012

(30) Foreign Application Priority Data
Aug. 3, 2011 (KR) 1020110077256

(51) Int. Cl. H04N 7/18

(52) U.S. Cl. 348/135; 348/E07.085

(57) ABSTRACT

Disclosed herein are a camera system and a method for recognizing a distance using the same. The camera system includes: a reflector that forms an input picture in a predetermined region of an image sensor through a lens; a lens that transfers the picture transferred through the reflector to the image sensor; an image sensor that converts the picture in a light type through the lens into an image; and a distance recognition module that detects a spaced distance from a targeted object by analyzing the image converted by the image sensor.

### CROSS REFERENCE TO RELATED APPLICATION

This application claims the benefit of Korean Patent Application No. 10-2011-0077256, filed on Aug. 3, 2011, entitled “Camera System and Method for Recognition Distance Using the Same,” which is hereby incorporated by reference in its entirety into this application.

### BACKGROUND OF THE INVENTION

1. Technical Field

The present invention relates to a camera system and a method for recognizing a distance using the same.

2. Description of the Related Art

Recently, A recent trend in the automobile market seeks is to provide safety and convenience for users. Therefore, various sensors are applied to a car to improve safety and convenience for a driver.

According to the trend, cameras are mounted at a rear or a front of a car to provide a picture around a car to a driver and thus, services to confirm the picture with the naked eye are provided to the driver.

A front sensing function senses objects in front of a car by using radar, a liner, or the like, and a method of recognizing a distance has been used.

In this case, as the method for recognizing a distance, two cameras are mounted in a car by a stereo scheme and a method for calculating a distance using a phase difference between two cameras has been used.

However, a radar system has a problem in that a sensor itself is very expensive and the picture cannot be displayed. Meanwhile, the stereo scheme consumes much cost since two cameras needs to be mounted in a car.

Meanwhile, when two cameras are used in a car, performance of the camera depends on assembling tolerance of each camera and resolution of a lens and errors in the distance information according to the resolution of each camera and a difference in quality of an image sensor may occur.

### SUMMARY OF THE INVENTION

The present invention has been made in an effort to provide a camera system and a method for recognizing a distance using the same capable of acquiring pictures around a car by a single camera due to a use of a reflector and calculating a spaced distance from a targeted object.

According to a preferred embodiment of the present invention, there is provided a camera system, including: a reflector that forms an input picture in a predetermined region of an image sensor through a lens; a lens that transfers the picture transferred through the reflector to the image sensor; an image sensor that converts the picture in a light type through the lens into an image; and a distance recognition module that detects a spaced distance from a targeted object by analyzing the image converted by the image sensor.

The reflector may be a prism or a mirror.

The reflector may include a first reflector, a second reflector, and a third reflector all of which are disposed on the same line in parallel with one another and the first reflector and the third reflector may be disposed so as to be spaced apart from each other by a predetermined distance.

The reflector may include a first reflector, a second reflector, and a third reflector all of which are disposed on the same line in parallel with one another, and the picture input to the first reflector may be reflected by the second reflector and is input to a right of the image sensor, and the picture input to the third reflector may be reflected by the second reflector and is input to a left of the image sensor.

The reflector may include a first reflector, a second reflector, and a third reflector all of which are disposed on the same line in parallel with one another and the distance recognition module may include: an input unit that receives the image converted by the image sensor; an object recognition unit that compares the image received by the input unit with an object image stored in a memory and analyzes the compared image according to an object recognition reference recognizing an object to detect a targeted object; a distance estimation unit that estimates the spaced distance from the targeted object by analyzing the targeted object information of the first reflector and the third reflector recognized by the object recognition unit according to a distance estimation reference; a picture output unit that composes the image of the targeted object detected by the object recognition unit and the spaced distance from the targeted object detected by the distance estimation unit and outputs the composed result through the display unit; a display unit that outputs information transferred through the picture output unit; and a memory that stores information related with the camera system, including the object picture.

The camera system may further include: a warning sound output unit that outputs a warning sound when the spaced distance from the targeted object detected by the distance estimation unit does not correspond to a pre-stored safety distance reference.

The distance estimation reference may be

$${x}_{L} = \frac{{fx}_{w}}{{z}_{w}} , {x}_{R} = \frac{f ( {x}_{w} - d )}{{z}_{w}} and$$

$${z}_{w} = \frac{df}{( {x}_{L} - {x}_{R} )} = \frac{df}{D} ,$$

where z_{w}, represents the spaced distance from the targeted object, x_{L} represents a coordinate of a left picture of the image sensor input through the reflector 3, x_{R} represents a coordinate of a right picture of the image sensor input through the reflector 1, d represents a distance between the reflector 1 and the reflector 3, f represents a focusing distance, and D represents a pixel position difference between the x_{L} and the x_{R}.

According to another preferred embodiment of the present invention, there is provided a method for recognizing a distance of a targeted object in a camera system including a reflector and an image sensor, the method including: receiving an image input through the reflector and converted by the image sensor; comparing the received image with a pre-stored object picture and analyzing the compared image according to an object recognition reference recognizing an object to detect the targeted object; and analyzing the detected targeted object information according to the distance estimation reference to estimate a spaced distance from the targeted object.

The method for recognizing a distance may further include: composing and outputting the image of the targeted object and the spaced distance from the targeted object after the estimating of the spaced distance from the targeted object, wherein the reflector includes a first reflector, a second reflector, and a third reflector all of which are disposed on the same line in parallel with one another.

At the composing and outputting of the image of the targeted object and the spaced distance from the targeted object, the image of the targeted object may be any one of the image input through the first reflector or the third reflector.

The method for recognizing may further include: after the estimating of the spaced distance from the targeted object, comparing the spaced distance from the targeted object with the pre-stored safety distance reference; and outputting a warning sound when the spaced distance from the targeted object does not correspond to the safety distance reference as a result of the compared result.

The reflector may include a first reflector, a second reflector, and a third reflector all of which are disposed on the same line in parallel with one another, and the distance estimation reference may be

$${x}_{L} = \frac{{fx}_{w}}{{z}_{w}} , {x}_{R} = \frac{f ( {x}_{w} - d )}{{z}_{w}} and$$

$${z}_{w} = \frac{df}{( {x}_{L} - {x}_{R} )} = \frac{df}{D} ,$$

where z_{w} represents the spaced distance from the targeted object, x_{L} represents a coordinate of a left picture of the image sensor input through the reflector 3, x_{R} represents a coordinate of a right picture of the image sensor input through the reflector 1, d represents a distance between the reflector 1 and the reflector 3, f represents a focusing distance, and D represents a pixel position difference between the x_{L} and the x_{R}.

The reflector may be a prism or a mirror.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a configuration of a camera system in accordance with a preferred embodiment of the present invention;

FIG. 2 is a diagram showing a configuration of a distance recognition module in accordance with another preferred embodiment of the present invention;

FIG. 3 is a diagram for describing a method for recognizing a distance in accordance with another preferred embodiment of the present invention;

FIG. 4 is a flow chart for describing a method for recognizing a distance in accordance with the preferred embodiment of the present invention;

FIG. 5 is a flow chart for describing a method for recognizing a targeted object in accordance with another preferred embodiment of the present invention; and

FIG. 6 is a diagram showing an example of displaying a picture in accordance with another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

Camera System

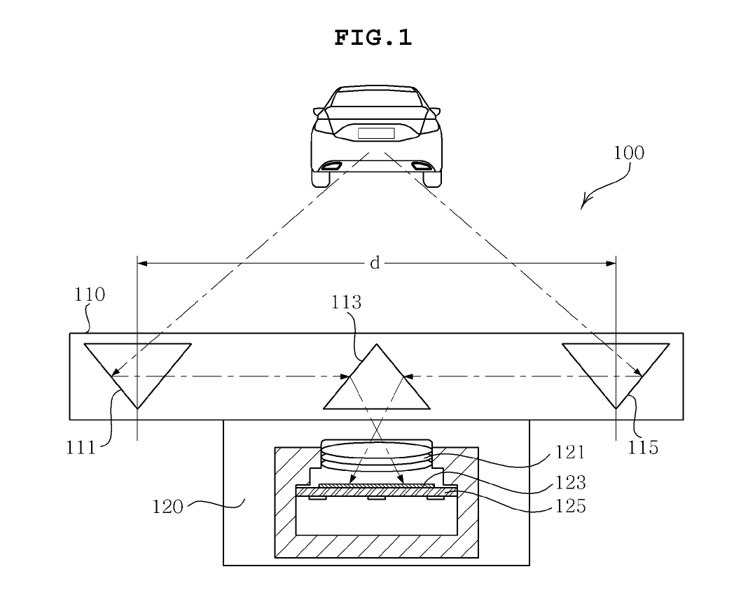

FIG. 1 is a diagram showing a configuration of a camera system in accordance with a preferred embodiment of the present invention.

As shown in FIG. 1, a camera system 100 is configured to include a reflector 110 that forms an input picture in a predetermined region of an image sensor 123 through a lens 121, a lens 121 that transfers a picture transferred through the reflector 110 to the image sensor 123, an image sensor 123 that converts a picture in a light type transmitting the lens 121 into an image, and a distance recognition module that analyzes an image converted by the image sensor 123 to detect a spaced distance from a targeted object.

Although not shown, the distance recognition module is connected to a camera module that includes the reflector 110, the lens 121, and the image sensor 123 to receive image information converted by the image sensor 123, thereby performing the image analysis.

In addition, the reflector 110 may be a prism or a mirror. FIG. 1 shows, by way of example, a case of the prism for convenience of explanation.

In addition, the reflector 110 is configured to include a first reflector 111, a second reflector 113, and a third reflector 115 having a triangular shape, all of which are disposed on the same line in parallel with one another, wherein the first reflector 111 and the third reflector 115 are disposed to have an inverted triangular shape capable of receiving an input picture and the second reflector 113 is disposed to have a triangular shape.

In this case, a disposition structure of the reflector 110 is not limited to the above-mentioned example and therefore, can be changed to more effectively receive the input picture.

In addition, the first reflector 111, the second reflector 113, and the third reflector 115 are configured in one group.

Meanwhile, the first reflector 111 and the third reflector 115 receiving the input picture may be disposed so as to be spaced apart from each other by a predetermined distance d.

The distance d is used when calculating the spaced distance from the targeted object.

As shown in FIG. 1, the picture input to the first reflector ill may be reflected by the second reflector 113 and then, is input to the right of the image sensor 123 and the picture input to the third reflector 115 may be reflected by the second reflector 113 and then, is input to the left of the image sensor 123.

Further, the image sensor 123 in accordance with the preferred embodiment of the present invention uses mega-level resolution (for example, 1280×800) and therefore, is not limited thereto.

The reason is that picture needs to be split into two pictures. For example, the picture by reflector 1 uses a 640×800 picture that is a half of the mega resolution and the picture by reflector 3 similarly uses a 640×800 picture.

In addition, one surface of the image sensor 123 may be provided with a printed circuit board 125 that is electrically connected to the image sensor 123.

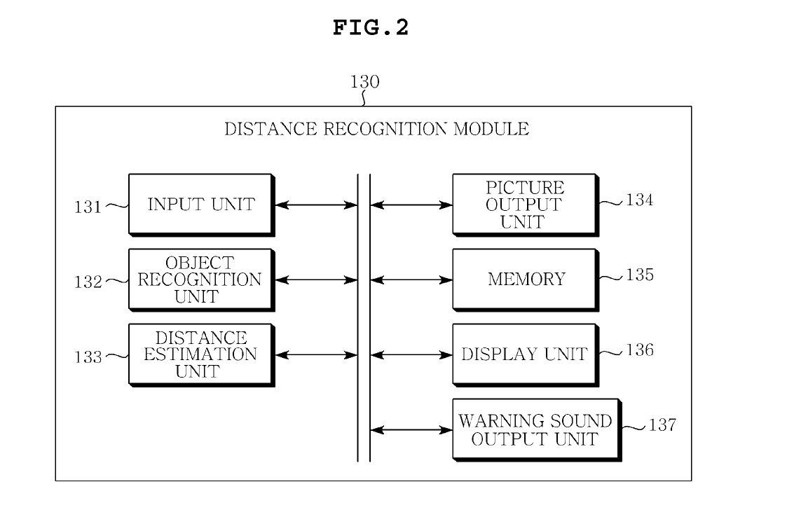

FIG. 2 is a diagram showing a configuration of a distance recognition module in accordance with the preferred embodiment of the present invention.

As shown in FIG. 2, a distance recognition module 130 may be configured to include an input unit 131 that receives an image converted by the image sensor 123, an object recognition unit 132 that compares the image received by the input unit 131 with an object picture stored in a memory 135 and analyzes the compared image according to an object recognition reference for recognizing an object to detect a targeted object, and a distance estimation unit 133 that analyzes targeted object information of the first reflector 111 and the second reflector 115 recognized by the object recognition unit 132 according to the distance estimation reference to estimate the spaced distance from the targeted object.

In addition, the distance recognition module 130 may further include an picture output unit 134 that composes the picture of the targeted object detected by the object recognition unit 132 and the spaced distance from the targeted object detected by the distance estimation unit 133 and outputs the composed image through the display unit 136, a display unit 136 that outputs information transferred through the picture output unit 134, and the memory 135 that stores information related to the camera system, including the object picture.

Further, the distance recognition module 130 may further include a warning sound output unit 137 that outputs a warning sound, when the spaced distance from the targeted object detected by the distance estimation unit 133 does not coincide with a pre-stored safety distance reference.

The display unit 136 may be a display that can display the picture, or the like, on a screen.

The above-mentioned object recognition unit 132 recognizes the targeted object by using the object recognition reference (for example, neural network algorithm). In this case, the neural network algorithm is a scheme of learning picture image patterns of various objects through an input layer and an output layer and when the picture of which the distance is to be recognized is input, displaying a representative point when the shape of the targeted object matches the image by performing a high pass filter on the image and then, inputting the image to an input term.

For example, the distance recognition module 130 previously stores the picture (targets (car, bus, motorcycle, truck, or the like) for the targeted object disposed on a road and a kind (pictures corresponding to each car, pictures corresponding to each bus, pictures corresponding to each motorcycle, images corresponding to each truck, or the like) of targets in the memory 135 and when the image is input through the input unit 131, compares the picture input through the object recognition unit 132 with the picture stored in the memory to recognize whether the targeted object is a car or a bus and detect the representative point that is a reference point for analyzing the distance.

Therefore, the distance information between the targeted object and the car (a car in which the camera system is mounted) is detected based on the representative point of the targeted object detected by the neural network algorithm.

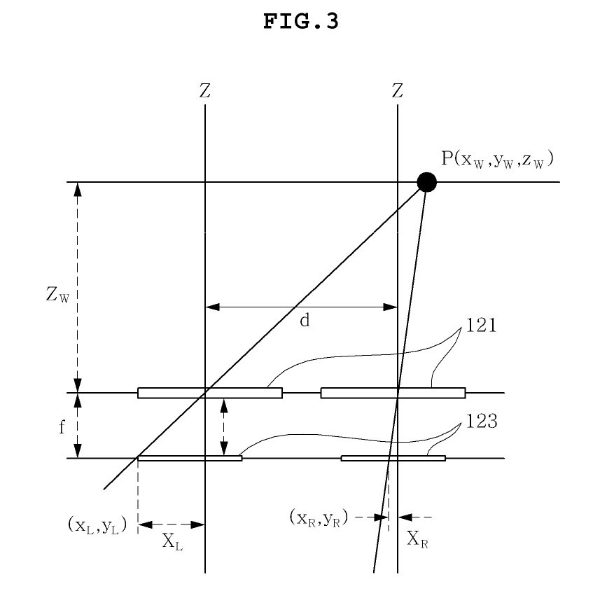

FIG. 3 is a diagram for describing a method for recognizing a distance according to the preferred embodiment of the present invention.

As shown in FIG. 3, the reflector 1 111 and the reflector 3 115 are disposed to have a distance d and form the input pictures at the right and left of the image sensor 123, respectively, through the lens 121.

In this case, the pictures formed at the left and right of the image sensor 123 each have the same focusing distance f and the spaced distance d between the reflector 1 111 and the reflector 3 115.

In addition, a position of a subject (targeted object) in a three-dimensional space is P(x_{w}, y_{w}, z_{w}) and coordinates of points of the images projected at the left and right each are (x_{L}, y_{L}) and (x_{R}, y_{R}).

The distance estimation unit 133 calculates the projected points according to a proportional relationship Equation of a triangular shape represented by Equation 1 and Equation 2, based on each configuration (reflector, lens, image sensor, or the like) disposed under the above-mentioned conditions and the predetermined conditions (the focusing distance f, the spaced distance d between the reflectors, or the like).

In this case, it can confirm an inversely proportional term to the depth information by using D as a displacement. The value can be calculated as three-dimensional information by using the same.

That is, the distance estimation reference may be represented by Equation 1 and Equation 2.

$$\begin{matrix}{x}_{L} = \frac{{fx}_{w}}{{z}_{w}} , {x}_{R} = \frac{f ( {x}_{w} - d )}{{z}_{w}} & [ Equation 1 ] \\ {z}_{w} = \frac{df}{( {x}_{L} - {x}_{R} )} = \frac{df}{D} & [ Equation 2 ]\end{matrix}$$

In the above Equations, z_{w} may represent the spaced distance from the targeted object, x_{L} may represent the coordinate of the left picture of the image sensor input through the reflector 3, x_{R} may represent the coordinate of the right picture of the image sensor input through the reflector 1, d may represent the distance between the reflector 1 and the reflector 3, f may represent the focusing distance, and D may be the pixel position difference between x_{L} and x_{R}.

Meanwhile, as shown in FIG. 6, the picture output unit 134 displays the pictures (the pictures of the targeted object) of a plurality of cars positioned in front thereof and spaced distances Am, Bm, and Cm therefrom, respectively, together, based on the information detected by the object recognition unit 132 and the distance estimation unit 133, and therefore, the driver can confirm pictures. In this case, FIG. 6 shows, by way of example, the case in which the camera system is installed to display the front of the car.

In addition, the picture output unit 134 extracts any one of the picture of the targeted object input through the reflector 1 111 and the picture of the targeted object input through the reflector 3 115 according to a setting value set by an operator and outputs the extracted image along with the corresponding spaced distance.

Since the color and resolution of the pictures input through the reflector 1 111 and the reflector 3 115 are the same as each other and therefore, any of two may be selected irrelevantly.

As a result, the camera system 100 in accordance with the preferred embodiment of the present invention can easily manage the picture input from the reflector 1 111 and the picture input from the reflector 3 115.

In addition, the camera system 100 in accordance with the preferred embodiment of the present invention can improve the accuracy of the distance detection due to the picture difference since the resolution of the pictures input from the reflector 1 111 and the picture input from the reflector 3 115 and the image quality of the image sensor are the same, thereby making it possible to provide the stabilized picture to the driver.

Method For Recognizing Distance

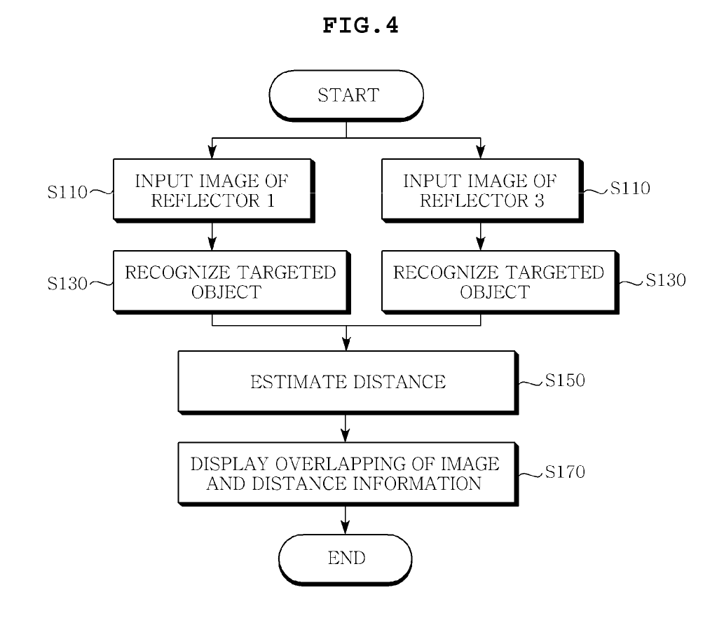

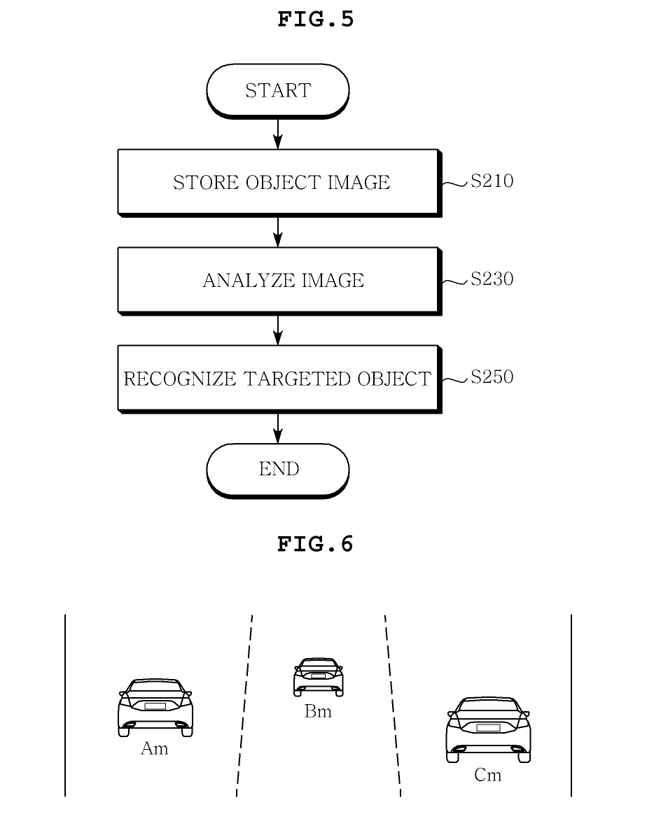

FIG. 4 is a flow chart for describing a method for recognizing a distance in accordance with the preferred embodiment of the present invention, which will be described with reference to FIG. 5 for describing a method for recognizing a targeted object and FIG. 6 showing an example of displaying a picture.

First, the input unit 131 of the distance recognition module 130 receives the image that is input through the reflector 110 and converted by the image sensor 123 (S110).

In this case, the reflector 110 is configured to include the first reflector 111, the second reflector 113, and the third reflector 115 all of which are disposed on the same line in parallel with one another.

Describing in more detail, the input unit 131 receives the image that are input from the reflector 1 111 and the reflector 3 115, respectively, and are transferred and converted to the image sensor 123 through the lens 121.

Next, the object recognition unit 132 compares the image received through the input unit 131 with the object picture pre-stored in the memory 135 and analyzes the compared image according to the object recognition reference recognizing the object, thereby detecting the targeted object (S130).

Describing in more detail, as shown in FIG. 5, the memory 135 of the distance recognition module 130 stores various object pictures for recognizing the targeted object (S210).

Next, the object recognition unit 132 recognizes the targeted object by using the object recognition reference (for example, neural network algorithm) (S230 and S250).

In this case, the neural network algorithm is a scheme of learning picture image patterns of various objects through an input layer and an output layer and when the picture of which the distance is to be recognized is input, displaying a representative point when the shape of the targeted object matches the image by performing a high pass filter on the image and then, inputting the image to an input term.

Next, the distance information between the targeted object and the car is detected based on the representative point of the targeted object detected by the neural network algorithm.

Next, the distance estimation unit 133 analyzes the information (the shape of the targeted object, the representative point, or the like) of the targeted object detected by the object recognition unit 132 according to the distance estimation reference to estimate the spaced distance from the targeted object (S150).

Describing in more detail, the distance estimation unit 133 analyzes the targeted object information of the first reflector 111 and the third reflector 115 recognized by the object recognition unit 132 according to the distance estimation reference to estimate the spaced distance from the targeted object.

Here, the distance estimation reference may be represented by Equation 1 and Equation 2.

In this case, the spaced distance d between the reflector 1 111 and the reflector 3 115 and the focusing distance f are the initial set information.

Next, the picture output unit 134 composes and outputs the picture of the targeted object and the spaced distance from the targeted object (S170).

For example, when the camera system is installed to display the front of the car, as shown in FIG. 6, the picture output unit 134 displays the pictures of a plurality of cars disposed in front thereof and the spaced distances Am, Bm, and Cm therefrom, respectively, together, and therefore, the driver can confirm the pictures.

In this case, the picture output unit 134 extracts any one of the picture of the targeted object input through the reflector 1 111 and the picture of the targeted object input through the reflector 3 115 according to a setting value set by the operator and outputs the extracted image along with the corresponding spaced distance.

Since the color and resolution of the pictures input through the reflector 1 111 and the reflector 3 115 are the same as each other and therefore, any of two may be selected irrelevantly.

As a result, the camera system 100 in accordance with the preferred embodiment of the present invention can easily manage the picture input from the reflector 1 111 and the picture input from the reflector 3 115.

In addition, the camera system 100 in accordance with the preferred embodiment of the present invention can improve the accuracy of the distance detection due to the picture difference since the resolution of the pictures input from the reflector 1 111 and the picture input from the reflector 3 115 and the image quality of the image sensor are the same, thereby making it possible to provide the stabilized picture to the driver.

Meanwhile, although not shown, after S 150, the warning sound output unit 137 compares the spaced distance from the targeted object with the pre-stored safety distance reference.

As the result of the comparison, when the spaced distance from the targeted object does not correspond to the safety distance reference, the warning sound output unit 137 outputs a warning sound, such that the driver can recognize the warning sound.

In accordance with the preferred embodiments of the present invention, the camera system and the method for recognizing a distance using the same can implement the stereo system having the single lens group and the image sensor according to the use of the reflector to acquire the same picture as the specific targeted object, thereby providing the stabilized picture.

In addition, the preferred embodiments of the present invention can implement the stereo system based on the single lens group and the image sensor according to the use of the reflector, thereby further reducing the costs of the system than the existing scheme.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A camera system, comprising:
a reflector that forms an input picture in a predetermined region of an image sensor through a lens;
a lens that transfers the picture transferred through the reflector to the image sensor;
an image sensor that converts the picture in a light type through the lens into an image; and
a distance recognition module that detects a spaced distance from a targeted object by analyzing the image converted by the image sensor.

2. The camera system as set forth in claim 1, wherein the reflector is a prism or a mirror.

3. The camera system as set forth in claim 1, wherein the reflector includes a first reflector, a second reflector, and a third reflector all of which are disposed on the same line in parallel with one another, and
the first reflector and the third reflector are disposed so as to be spaced apart from each other by a predetermined distance.

4. The camera system as set forth in claim 1, wherein the reflector includes a first reflector, a second reflector, and a third reflector all of which are disposed on the same line in parallel with one another,
the picture input to the first reflector is reflected by the second reflector and is input to a right of the image sensor, and
the picture input to the third reflector is reflected by the second reflector and is input to a left of the image sensor.

5. The camera system as set forth in claim 1, wherein the reflector includes a first reflector, a second reflector, and a third reflector all of which are disposed on the same line in parallel with one another, and the distance recognition module includes:
an input unit that receives the image converted by the image sensor;
an object recognition unit that compares the image received by the input unit with an object image stored in a memory and analyzes the compared image according to an object recognition reference recognizing an object to detect a targeted object;
a distance estimation unit that estimates the spaced distance from the targeted object by analyzing the targeted object information of the first reflector and the third reflector recognized by the object recognition unit according to a distance estimation reference;
a picture output unit that composes the image of the targeted object detected by the object recognition unit and the spaced distance from the targeted object detected by the distance estimation unit and outputs the composed result through the display unit;
a display unit that outputs information transferred through the picture output unit; and
a memory that stores information related with the camera system, including the object picture.

6. The camera system as set forth in claim 5, further comprising: a warning sound output unit that outputs a warning sound when the spaced distance from the targeted object detected by the distance estimation unit does not correspond to a pre-stored safety distance reference.

7. The camera system as set forth in claim 5, wherein the distance estimation reference is
$${x}_{L} = \frac{{fx}_{w}}{{z}_{w}} , {x}_{R} = \frac{f ( {x}_{w} - d )}{{z}_{w}} and {z}_{w} = \frac{df}{( {x}_{L} - {x}_{R} )} = \frac{df}{D} ,$$
where z_{w} represents the spaced distance from the targeted object, x_{L} represents a coordinate of a left picture of the image sensor input through the reflector 3, x_{R} represents a coordinate of a right picture of the image sensor input through the reflector 1, d represents a distance between the reflector 1 and the reflector 3, f represents a focusing distance, and D represents a pixel position difference between the x_{L} and the x_{R}.

8. A method for recognizing a distance of a targeted object in a camera system including a reflector and an image sensor, the method comprising:
receiving an image input through the reflector and converted by the image sensor;
comparing the received image with a pre-stored object picture and analyzing the compared image according to an object recognition reference recognizing an object to detect the targeted object; and
analyzing the detected targeted object information according to the distance estimation reference to estimate a spaced distance from the targeted object.

9. The method as set forth in claim 8, further comprising: composing and outputting the image of the targeted object and the spaced distance from the targeted object, after the estimating of the spaced distance from the targeted object,
wherein the reflector includes a first reflector, a second reflector, and a third reflector all of which are disposed on the same line in parallel with one another.

10. The method as set forth in claim 9, wherein at the composing and outputting of the image of the targeted object and the spaced distance from the targeted object, the image of the targeted object is any one of the image input through the first reflector or the third reflector.

11. The method as set forth in claim 8, further comprising: after the estimating of the spaced distance from the targeted object,
comparing the spaced distance from the targeted object with the pre-stored safety distance reference; and
outputting a warning sound when the spaced distance from the targeted object does not correspond to the safety distance reference as a result of the compared result.

12. The method as set forth in claim 8, wherein the reflector includes a first reflector, a second reflector, and a third reflector all of which are disposed on the same line in parallel with one another, and
the distance estimation reference is
$${x}_{L} = \frac{{fx}_{w}}{{z}_{w}} , {x}_{R} = \frac{f ( {x}_{w} - d )}{{z}_{w}} and$$
$${z}_{w} = \frac{df}{( {x}_{L} - {x}_{R} )} = \frac{df}{D} ,$$
where z_{w} represents the spaced distance from the targeted object, x_{L} represents a coordinate of a left picture of the image sensor input through the reflector 3, x_{R} represents a coordinate of a right picture of the image sensor input through the reflector 1, d represents a distance between the reflector 1 and the reflector 3, f represents a focusing distance, and D represents a pixel position difference between the x_{L} and the x_{R}.

13. The method as set forth in claim 8, wherein the reflector is a prism or a mirror.
